(19) United States
(12) Patent Application Publication
(10) Pub. No.: US 2013/0311482 A1
(43) Pub. Date: Nov. 21, 2013

(54) MULTI-USER TIMELINE FOR FACILITATING SOCIAL DISCOVERY IN SOCIAL NETWORKING ENVIRONMENTS

(71) Applicant: Tagged, Inc., San Francisco, CA (US)

(72) Inventors: Johann Schleier-Smith, San Francisco, CA (US); Greg Tseng, Los Altos, CA (US); Jared Kim, San Francisco, CA (US)

(21) Appl. No.: 13/833,243

(22) Filed: Mar. 15, 2013

Related U.S. Application Data
(60) Provisional application No. 61/648,346, filed on May 17, 2012.

(51) Int. Cl. G06F 17/30

(52) U.S. Cl. CPC G06F 17/30551; G06F 17/30336
USPC 707/746

(57) ABSTRACT

Systems and methods for generating a common social timeline to facilitate social discovery in a social networking environment are disclosed. In one aspect, embodiments of the present disclosure include a method, which may be implemented on a system, of receiving user data items associated with users of the web-based social network, associating a time indicator with each of the data items, processing the data items to identify a first set of data items that are common to a first user and a second user, and generating a common social timeline that illustrates a temporal relationship between each of the first set of data items and one or more time scale identifiers.

### CLAIM OF PRIORITY

This application claims priority to U.S. Provisional Patent Application No. 61/648,346 entitled “MULTI-USER TIMELINE FOR FACILITATING SOCIAL DISCOVERY IN SOCIAL NETWORKING ENVIRONMENTS,” which was filed on May 17, 2012, Attorney Docket No. 58520-8010.US00, the contents of which are expressly incorporated by reference herein.

### CROSS-REFERENCE TO RELATED APPLICATION

This application is related to co-pending U.S. patent application Ser. No. ______, entitled “SYSTEMS AND METHODS FOR GENERATING AUTOMATED SOCIAL NETWORKING INTERACTIONS”, which has been concurrently filed on even date herewith, Attorney Docket No. 58520-8011.US01, the contents of which are expressly incorporated by reference herein.

This application is related to co-pending U.S. patent application Ser. No. ______, entitled “SOCIAL DISCOVERY FEED FOR FACILITATING SOCIAL EXPLORATION IN SOCIAL NETWORKING ENVIRONMENTS”, which has been concurrently filed on even date herewith, Attorney Docket No. 58520-8013.US01, the contents of which are expressly incorporated by reference herein.

### BACKGROUND

Social networks in online environments are increasingly relied upon by individuals to engage and participate in various types of social activities and behaviors. For example, individuals use online social networks to facilitate friendly, casual, romantic, business relationships and to maintain connections and initiate dialogues with others. With the prevalence of high speed network connections to the Internet and the availability of mobile devices with wireless capabilities, the online environment has become one of the dominating mechanisms through which people communicate and connect with one another.

For example, online social networks are increasingly used by many individuals of all ages and demographic groups to stay in touch and to stay connected with existing friends, family members, and business colleagues. Further, online social networks are also increasingly being used to build connections, acquaintances, or potential business partners. Via these online social networks, users can join common interest groups, meet others with similar interests, and/or have access to updated contact information for contacts, friends, and/or acquaintances. The vast and continuously growing user-base of online social networks further enhances the user's experience. However, the amount of relationship data and interaction data that users can collect and utilize makes finding and nurturing new social connections increasingly burdensome.

### BRIEF DESCRIPTION OF THE DRAWINGS

FIG. 1 illustrates a block diagram of client devices or user devices able to communicate with the host server for generating a multi-user common social timeline for facilitating social discovery in a web-based social networking environment, according to one embodiment.

FIG. 2 depicts a block diagram of the components of a host server that generates a multi-user common social timeline for facilitating social discovery in a web-based social networking environment, according to one embodiment.

FIG. 3 depicts a flow diagram illustrating an example process for managing received data items from a plurality of users of a web-based social networking environment, according to one embodiment.

FIG. 4A and FIG. 4B depict diagrams illustrating examples of operation of a host server in processing incoming data items initiated by a first user A and a second user B, respectively, according to one embodiment.

FIG. 5 depicts a table illustrating an example of data items that are common to a first user and a second user, according to one embodiment.

FIG. 6 illustrates an example multi-user common social timeline, according to an embodiment.

FIG. 7A and FIG. 7B illustrate example user interfaces showing user-profile pages for entering personal history and professional history, respectively, according to one embodiment.

FIG. 8 illustrates an example user interface showing a user-profile page, according to one embodiment.

FIG. 9 depicts a flow diagram illustrating an example process for generating a multi-user common social timeline for facilitating social discovery in a web-based social networking environment, according to one embodiment.

FIG. 10 illustrates an example user interface showing the multi-user common social timeline, according to one embodiment.

FIG. 11 shows a diagrammatic representation of a machine in the example form of a computer system within which a set of instructions, for causing the machine to perform any one or more of the methodologies discussed herein, may be executed, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for generating a multi-user common social timeline for facilitating social discovery in a web-based (or Internet-based) social networking environment. More specifically, the techniques introduced herein provide for systems and methods for generating a multi-user common social timeline which includes a plurality of data items that are common to two or more users. The common social time temporally illustrates the plurality of data items that are common to the two or more users for which the social timeline is generated. Accordingly, the multi-user common social timeline described herein conveys information about how a social network user's “path” crosses with other users “paths.” This information can be useful to facilitate exploration and new social connections.

In some embodiments, the information displayed in the timeline (i.e., data items) can be characterized into three broad categories: commonalities, messages, and actions. Commonalities can be visual indications of common data items such as, for example, users having indicated in their profiles that they lived or worked at the same place, or users having indicated in their profiles the same (or similar) fan status (e.g., both users like the San Francisco Giants). Messages can be visual indications of past engagements through communications. For example, messages can be any text-based message sent via the social networking interface including, but not limited to, email messages and/or chat messages. The actions can be visual indications of electronic events initiated by the user within the social networking environment. For example, a user may send to another user: an indication that the user would like to meet the other user, an indication that the user liked something (e.g., a picture of the other user), an indication of a virtual gift (e.g., a virtual monetary or virtual collectable), an indication of a non-text based communication (e.g., a wink), and/or an indication that a user tagged another user.

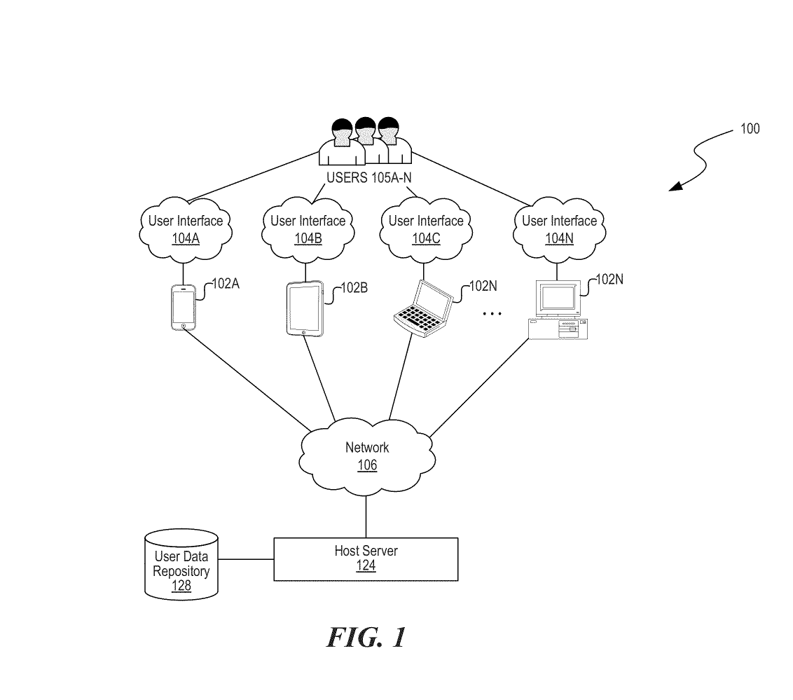

FIG. 1 illustrates a block diagram of client devices or user devices 102A-N able to communicate with the host server 124 for generating a common social timeline for facilitating social discovery in a web-based social networking environment 100, according to one embodiment.

The plurality of client devices or user devices 102A-N can be any system and/or device, and/or any combination of devices/systems that is able to establish a connection with another device, a server and/or other systems. The client devices or user devices 102A-N typically include display or other output functionalities to present data exchanged between the devices to a user. For example, the client devices can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, client devices or user devices 102A-N are coupled to a network 106. In some embodiments, the devices 102A-N may be directly connected to one another.

The network 106, over which client devices or user devices 102A-N and the host server 124 communicate, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc. The network 106 can be any collection of distinct networks operating wholly or partially in conjunction to provide connectivity to the client devices or user devices 102A-N and host server 124 and may appear as one or more networks to the serviced systems and devices. In one embodiment, communications to and from client devices or user devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The user data repository 128 can store software, descriptive data, images, system information, drivers, and/or any other data item utilized by other components of the host server 124 and/or any other servers for operation. The user data repository 128 may be coupled to the host server 124. The user data repository 128 may be managed by a database management system (DBMS), for example but not limited to, Oracle, DB2, Microsoft Access, Microsoft SQL Server, PostgreSQL, MySQL, FileMaker, etc. The user data repository 128 can be implemented via object-oriented technology and/or via text files, and can be managed by a distributed database management system, an object-oriented database management system (OODBMS) (e.g., ConceptBase, FastDB Main Memory Database Management System, JDOlnstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 124 is able to provide data to be stored in the user data (or data item) repository 128 and/or can retrieve data stored in the user data repository 128. The user data repository 128 can store static user data and dynamic user data. The status user data can include user information of the users in the online social network. For example, static user data can include descriptive data of current and past personal information such as, but not limited to, a first name and last name of the user, a valid email ID, a unique user name, age, marital status, occupations, locations lived and worked, education, home town, schools attended, number of siblings, heritage, ethnicity, race, etc. The user information further includes interest information, which may include, but is not limited to, activities, hobbies, professional information, photos, etc.

In one embodiment, the user data stored in user data repository 128 is explicitly specified by the user. For example, when the user (e.g., visitor/service subscriber) signs up for services such as social networking related services, a set of information may be required, such as a valid email address, an address of service, a valid credit card number, social security number, a username, and/or age. The user information form can include optional entries, by way of example but not limitation, location, activity, hobbies, ethnicity, photos, etc. Examples of user data stored in the user data repository 128, including, but is not limited to, user name, user occupation/position, user address, subscription information, hardware ID, hardware model, software version ID, etc. The user data may be entered by a user via a profile. In some cases, each user data may include additional information about whether the user information is public and/or private. For example, the information may include privacy information indicating what, if anything, other users of the social network can view with respect to the user data.

The user data repository 128 can also store dynamic user data. Dynamic user data can either be explicitly submitted by the user or provided via one or more software agents and/or hardware modules such as the host server 124 coupled to the user data repository 128. Dynamic user data can be any action or communication initiated by a user of the social network. For example, a user can periodically update his/her user profile which can be stored in the user data repository 128. Similarly, user preferences can be automatically identified and stored in the repository.

In some embodiments, dynamic information or activities such as user interactions (social interactions), relationships with other users, user connections, social records, social history records, and/or any communication records can be recorded and stored in the user data repository 128. In this manner, the dynamic user data essentially tracks the electronic actions that a user performs within the social networking environment. Examples of dynamic information include, but are not limited to, indications that a user would like to meet another user, indications that a user liked something, indications that a virtual gift was sent or received, indications that a wink was sent or received, and/or indications that a user tagged another user or was tagged by another user. Any electronic action that a user can take within the social network comprises dynamic user data. The user data repository 128 is shown as a discrete component in the example of FIG. 1; however, in some embodiments, the user data repository 128 may be included in the host server 124. Additionally, in some embodiments, the user data repository and/or the host server 124 may be both physically and/or functionally distributed.

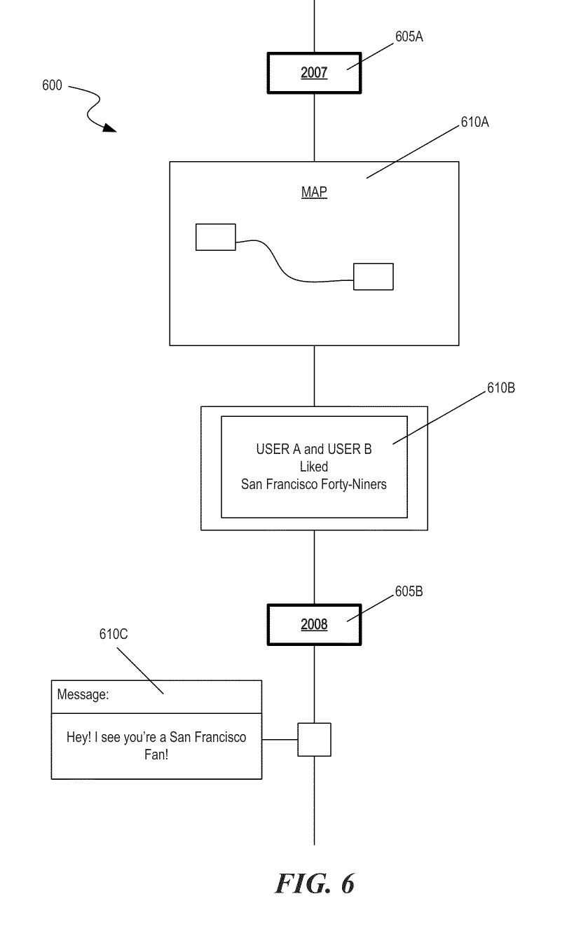

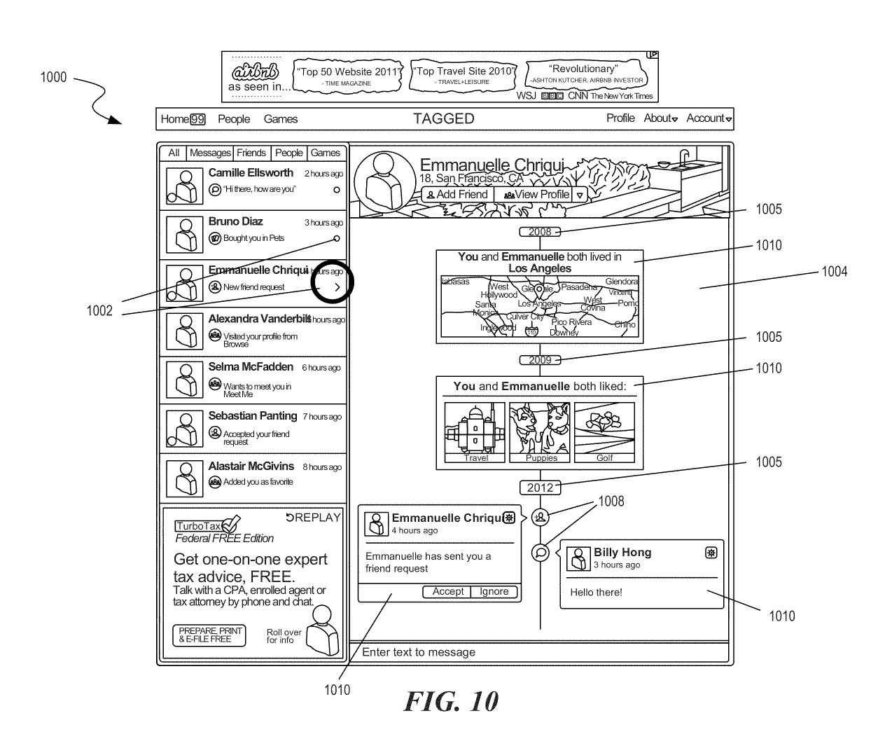

In one embodiment, the host server 124 is configured to facilitate social exploration in the web-based social networking environment 100. The host server 124 facilitates the social exploration by generating a multi-user common social timeline that illustrates a temporal relationship between data items that are common to two or more users. The multi-user common social timeline can be displayed to a user 105 via a user interface 104. Examples of multi-user common social timelines are illustrated and discussed in greater detail with respect to FIG. 6 and FIG. 10.

In one embodiment, some of all of the functionally described herein with respect to the host server 124 can be alternatively or additionally performed, in whole or in part, at one or more of the client devices or user devices 102A-N.

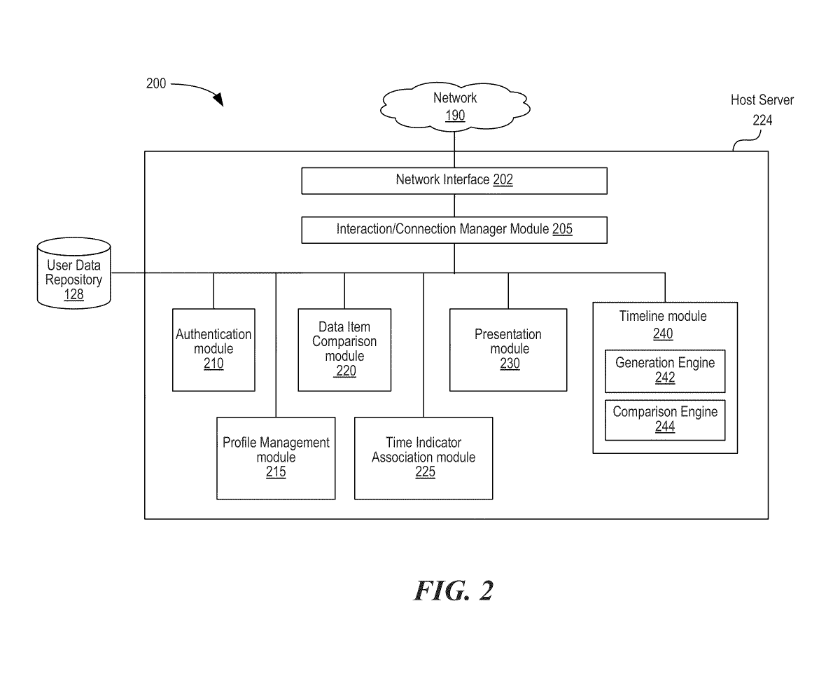

FIG. 2 depicts a block diagram of the components of a host server 224 that generate a multi-user common social timeline for facilitating social discovery in a web-based social networking environment, according to one embodiment.

The host server 224 includes a network interface 202, an interaction/connection manager module 205, an authentication module 210, a profile management module 215, a data item comparison module 220, a time indicator association module 225, a presentation module 230, and a timeline module 240. In one embodiment, the host server 224 is coupled to a user data repository 128. The user data repository 128 is described in greater detail with reference to the example of FIG. 1. Additional or less modules can be included without deviating from the novel art of this disclosure. In addition, each module in the example of FIG. 2 can include any number and/or combination of sub-modules and/or systems, implemented with any combination of hardware and/or software.

The host server 224, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 2, the network interface 202 can be a networking device that enables the host server 224 to mediate data in a network with an entity that is external to the host server, through any known and/or convenient communications protocol supported by the host and the external entity. The network interface 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

One embodiment of the host server 224 includes the interaction/connection manager module 205. The interaction/connection manager module 205 can be any combination of software agents and/or hardware modules able to identify, detect, track, manage, record, and/or process an occurrence of an interaction, an action, a relationship, an existing connection, and/or a requested connection. The interaction/connection manager module 205, when in operation, is able to communicate with the network interface 202 to identify and detect and/or receive data items including, but not limited to, a set of social interactions or social connection that occurred among multiple users in an online social network. In general, the social interactions that occurred in the online social network are initiated by users using client devices or user devices (e.g., a cell phone, a telephone, a SmartPhone, a PDA, an iPhone, a Blackberry, a computer, a laptop, and/or a Palmtop, etc.). Any type of connections or interactions can be detected and subsequently tracked and/or received and/or recorded for further processing and analysis. The types of connections/social connections can include relationships of various types (e.g., friendship, collegial, family, romantic, gaming, etc.) or relationships/connections of unspecified types. A connection in an online social network generally refers to users who have requested and accepted a connection request and are thus mutually connected.

The interactions/actions that occur in an online social network can include by way of example, but not limitation, sending or receiving an invitation to establish a social connection in the social network, sending or receiving a message, viewing a profile, posting a comment, posting information, joining a group, sending or receiving an invitation to an event or party, belonging to a group, creating a group, etc. The interaction/connection manager module 205 records these actions and determines the sender and recipient of these actions. If the action pertains to a group, the interaction/connection manager module 205 also determines and stores the associated group.

In one embodiment, the social interactions detected by the interaction/connection manager module 205 also includes sending a notification of interest, receiving a notification of interest, and/or responding to a notification of interest. For example, a notification of interest may be sent to a relevant user identified for a particular user when the particular user has indicated interest. The relevant user may respond to the notification if also interested in the particular user. Note that the notifications of interest sent to the particular user may be anonymous or non-anonymous. More specific examples of notifications of interest can include, but are not limited to, indications that a user would like to meet another user, indications that a virtual gift was sent or accepted, indications that a wink was sent or accepted, and/or indications that a user tagged another user. These interactions (also referred to as actions herein) are also tracked by the interaction/connection manager module 205.

In one embodiment, the interaction/connector module 205 determines the date/time of the occurrence of the event and stores the timestamp associated with the occurrence. The date and/or time associated with the occurrence of the event is used in the generation of the social timelines which illustrate the temporal relationships between various events (i.e., data items) associated with two or more users and graphically illustrates these relationships to one or more of the two or more users.

One embodiment of the host server 224 includes the authentication module 210. The authentication module 210 can be any combination of software agents and/or hardware components able to manage and register users of host server 224. For example, the authentication module 210 is configured to register new users with the system and/or create new accounts with the host server 224. During registration the user can provide, among other things, login credentials. The authentication module 210 is configured to authenticate the users as they access the host server 224 from a variety of devices. In some embodiments, authentication occurs by associating a user's username and password with an existing user account. Unauthorized users can be directed to register with the system.

One embodiment of the host server 224 includes the profile management module 215. The profile management module 215 can be any combination of software agents and/or hardware components able to control and manage modifications to user profiles. For example, a user can periodically update his/her user profile which can be stored in the user data repository 128. The user profile can include a variety of personal information describing the user. Some of this information can be public information that other users can view and some of the information can be private. Likewise some information in a users profile may be viewable some users but not by others. For example, social connections or friends of the user may be able to view the user's profile while non-social connections are not able to view the user's profile.

One embodiment of the host server 224 includes the data item comparison module 220. The data item comparison module 220 can be any combination of software agents and/or hardware components able to access data items in the user data repository 128 and/or in the interaction/connection manager module 205 and to process the plurality of data items and determine which data items are common (e.g., the same or similar). The data item comparison module 220, when in operation, is able to communicate with the interaction/connection manager module 205 and/or the user data repository 128 to access the data items. As discussed, the data items can include, but are not limited to, social connections and/or social history records, etc.

The data item comparison module 220 may take any number of factors and/or parameters into account when determining the interaction between the various events. For example, if two users indicated in their profiles that they lived or worked at the same place, then the data item comparison module 220 will determine that these events are common. In some embodiments, the data item comparison module 220 determines that the events are the same if they occur within some threshold. For example, in the case of two users indicating in their profiles that they lived or worked at the same place, the data item comparison module 220 may determine that they are the same or similar event if the two geographical areas are within some threshold (e.g., within 25 miles of one another). In one embodiment, users can specify and or adjust certain thresholds and parameters defined in the data item comparison module 220.

In one embodiment, the data item comparison module 220 also compares the associated time indicators prior to making a determination that the events are common. For example, the events may be valid during specified time period and the data item comparison module 220 may consider the events common only if the events are the same or similar and have overlapping time indicators. Continuing with the example above wherein two users indicate in their profiles that they lived or worked at the same place, the data item comparison module 220 will compare these two geographical areas and if they are the same (or a similar area) and if they have overlapping time indicators (or periods) during which they are valid then the data item comparison module 220 will mark them as common events (or data items). For example, if user A indicates that he/she has lived in San Francisco from 1997-Present and user B indicates that he/she lived in San Francisco from 2008-2010, then the data item comparison module 220 determines that these events are common for the period from 2008-2010. In one embodiment, the data item comparison module 220 marks and/or saves an indication of the common event and the overlapping time indicators.

One embodiment of the host server 224 includes the time indicator association module 225. The time indicator association module 225 can be any combination of software agents and/or hardware components able to receive data items from the user data repository 128 and/or the interaction/connection manager module 205, determine whether the data items have time indicators included with them, determine time indicators for the activities if time indicators are not included, associate the time indicator with the activities, and/or store the activities associated with the associated time indicators. Unlike the interaction/connection manager module 205 which can determine the date/time of the occurrence of the event, the time indicator association module 225 determines if the event (or data item) already includes a time indicator that identifies a time period during which the associated event is/was valid. For example, a user may modify his/her personal profile information to indicate an event (e.g., working at a specific place) and include with the event a time indicator (e.g., 2008 or a time period 2007-2008). Similarly, a time indicator can indicate an ongoing event with an ongoing time period (e.g., 2007-present).

One embodiment of the host server 224 includes a presentation module 230. The presentation module 230 can be any combination of software agents and/or hardware modules able to present a multi-user common social timeline to a client device for electronic presentation to a user. In one embodiment, the presentation module 230 is coupled the timeline module 240 and the user data repository 128. When in operation, the presentation module 230 identifies an active user (e.g., the user that sent the request to generate the multi-user common social timeline) and presents the multi-user common social timeline to an associated client device for electronic presentation to a user. The user device may be, for example, a computer, laptop, cell phone, Blackberry, iPhone, etc. The presented timeline information can include images, and/or textual information, and/or time descriptors for the social timeline.

One embodiment of the host server 224 includes the timeline module 240. The timeline module 240 can be any combination of software agents and/or hardware components able to generate a multi-user common social timeline for facilitating social discovery in a web-based social networking environment. Additionally, in some embodiments, the timeline module 240 also can generate individual timelines associated with a single user and compare the single user timelines to generate a multi-user common social timeline. The timeline module 240, when in operation, is able to communicate with the data item comparison module 220 to identify and detect and/or receive data items that are common to two or more users.

In one embodiment, the timeline module 240 includes a generation engine 242 and a comparison engine 244. The generation engine 242 is configured to generate a multi-user common social timeline which illustrates a temporal relationship between each data item that is common to two or more users. Additionally, in some embodiments, the timeline module 240 also can generate individual timelines associated with a single user.

The generation engine 242 can generate data item descriptors for each data item that is common to the two or more users. The generation engine 242 can subsequently determine an overlapping time indicator for the data items that are common to the two or more users. The overlapping time indicator is the time period during which the common data item associated with the first user and the common data item associated with the second user is valid. For example, if user A worked at company XYZ from 1994-2001 and user B worked at company XYZ from 2000-2004, the resulting overlapping time period is 2000-2001. The generation engine 242 also determines the one or more time scale identifiers that (i.e., the scale) of the multi-user common social timeline. The one or more time scale identifiers may represent discreet points in time such as, for example, a month or year.

In generating the multi-user common social timeline, the generation engine 242 can be configured to display the data item descriptor across the entire overlapping time period, at the beginning of the period, and/or at the end of the period. In one embodiment, the generation engine 242 associated the overlapping time period with the data item descriptor and stores this information in the user data repository 128 for future access.

The timeline module 240 can also include a comparison engine 244. The comparison engine 244 is configured to compare the generated timelines to generate multi-user common social timelines. For example, the comparison engine 244 may compare a first single user timeline to a second single user timeline to identify commonalities between the two timelines and generate a multi-user common social timeline based on those commonalities.

Using the connections/interactions (or data items), the timeline module 240 can generate a representation of the set of social interactions in a timeline format. In the timeline, each data item that is common to two or more users can be represented visually or graphically via a single data item descriptor. Each data item descriptor visually provides information about the type of data item that is visually presented. For example, a data item may comprise a map illustrating a geographic area shared by two or more users for a common activity (e.g., working or living) during an overlapping time period. This information is visually portrayed to one or more of the two or more users so that the user can quickly and easily see what he/she has in common with the other user(s). Accordingly, the multi-user common social timeline facilitates social discovery and new social connections. Examples of multi-user common social timelines are illustrated and discussed in greater detail with respect to FIG. 6 and FIG. 10.

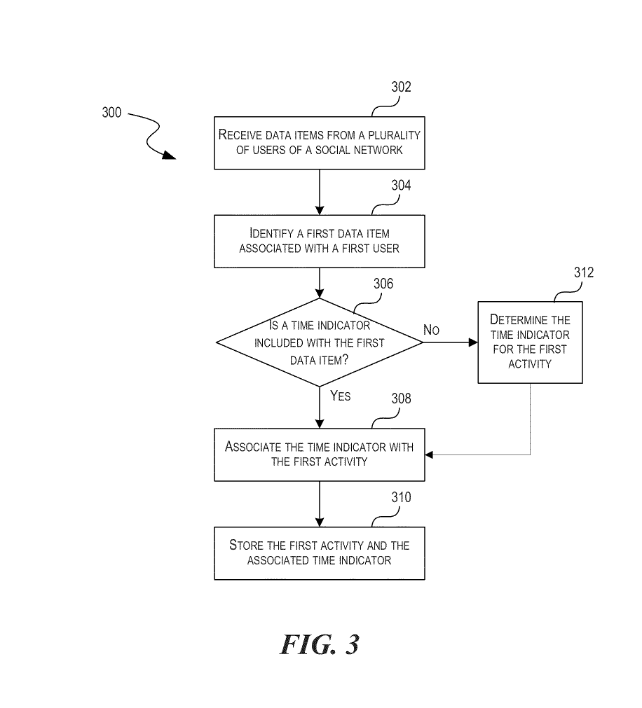

FIG. 3 depicts a flow diagram illustrating an example process 300 for managing data items received from a plurality of users of a web-based social networking environment such as, for example web-based social networking environment 100 of FIG. 1, according to one embodiment.

The operations or steps illustrated with respect to FIG. 3 are discussed with respect to operation of a host server such as, for example, host server 124 of FIG. 1. However, the operations or steps may be performed in various embodiments by a mobile device, such as, for example, client device or user device 102 of FIG. 1, one or more processors, and/or other components, modules, engines, or tools discussed herein. Additional or fewer data flow operations are possible.

In process 302, the host server receives data items from a plurality of users of a social network. For example, the host server may receive data items including, but not limited to, a set of social interactions or social connection that occurred among multiple users in an online social network. In general, the social interactions that occurred in the online social network are initiated by users using client devices or user devices (e.g., a cell phone, a telephone, a SmartPhone, a PDA, an iPhone, a Blackberry, a computer, a laptop, and/or a Palmtop, etc.). As discussed, any type of connections or interactions (or actions) can be detected and subsequently tracked and/or received and/or recorded for further processing and analysis.

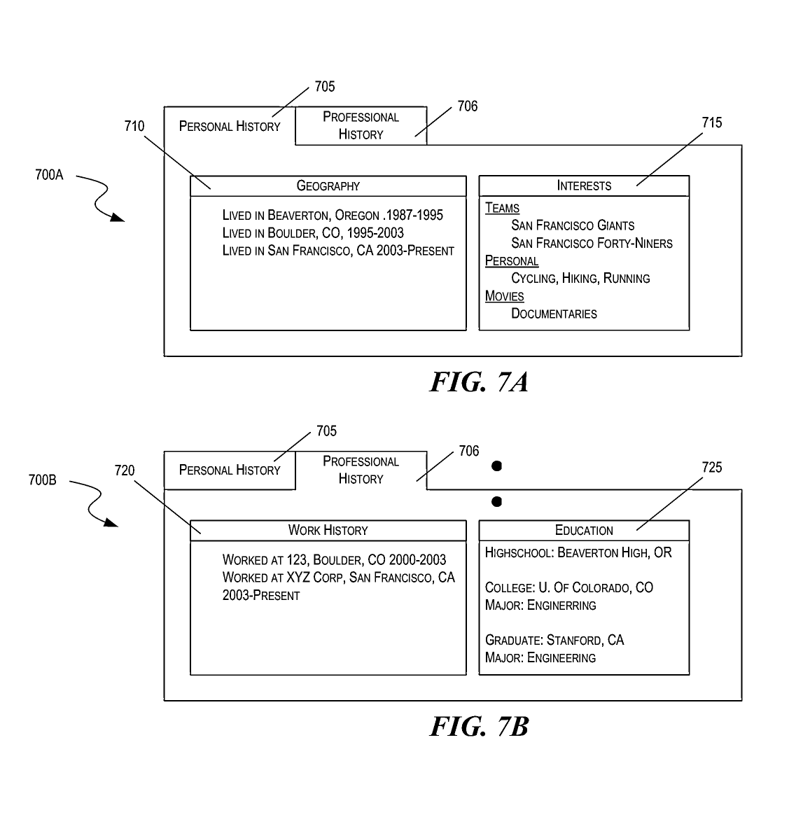

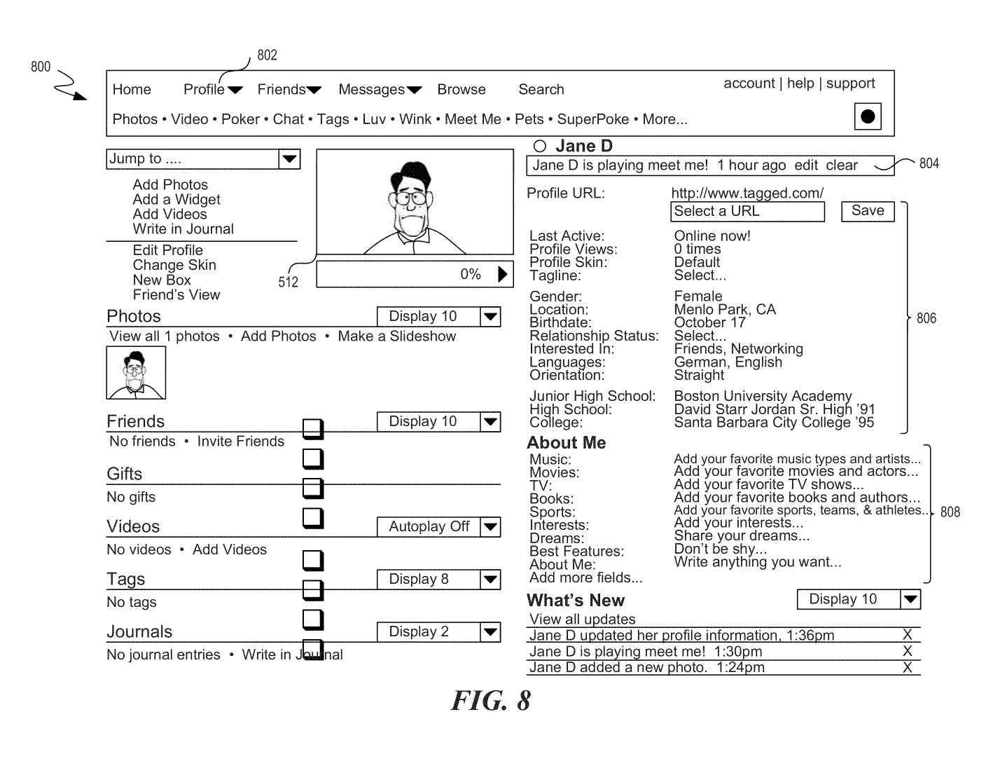

As discussed above, each of the social interactions that occurs in the online social network is initiated by a user. In process 304, the host server identifies a first data item associated with a first user. In process 306, the host server determines whether a time indicator is included with the first identified data item. Time indicators may be included with a data item in cases where a time period associated with the activity is relevant such as, for example, when a user modifies profile information that relates to areas or regions in where a user currently or previously lived or worked. Examples of user profile information that includes one or more time identifiers is discussed in greater detail above, with respect to FIG. 7A-7B and FIG. 8. If a time indicator is not associated with the first data item then, in process 312, the host sever determines a time indicator for the first data item. For example, a time of occurrence of the data item or activity may be identified or determined as the proper time indicator for the first data item.

Once the data item has been determined, or if a time indicator is already included with the first data item then, in process 308, the host server associates the time indicator with the first activity. Lastly, in process 310, the host server stores the first activity and the associated time indicator. For example, the host server can store the first activity and the associated time indicator in a user data repository such as, for example, the user data repository 128 of FIG. 1.

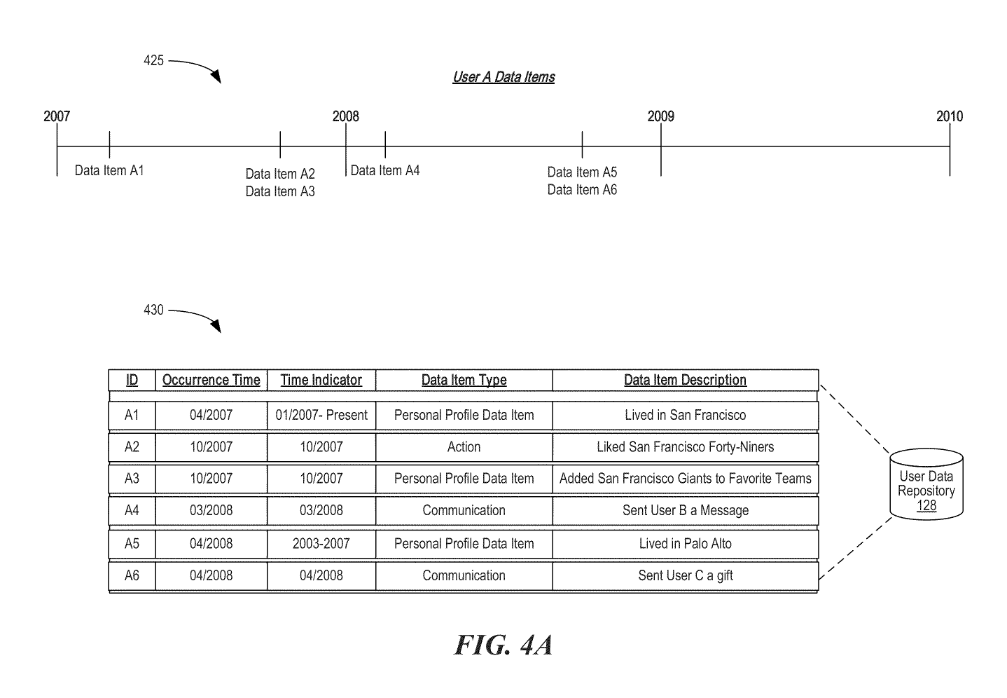

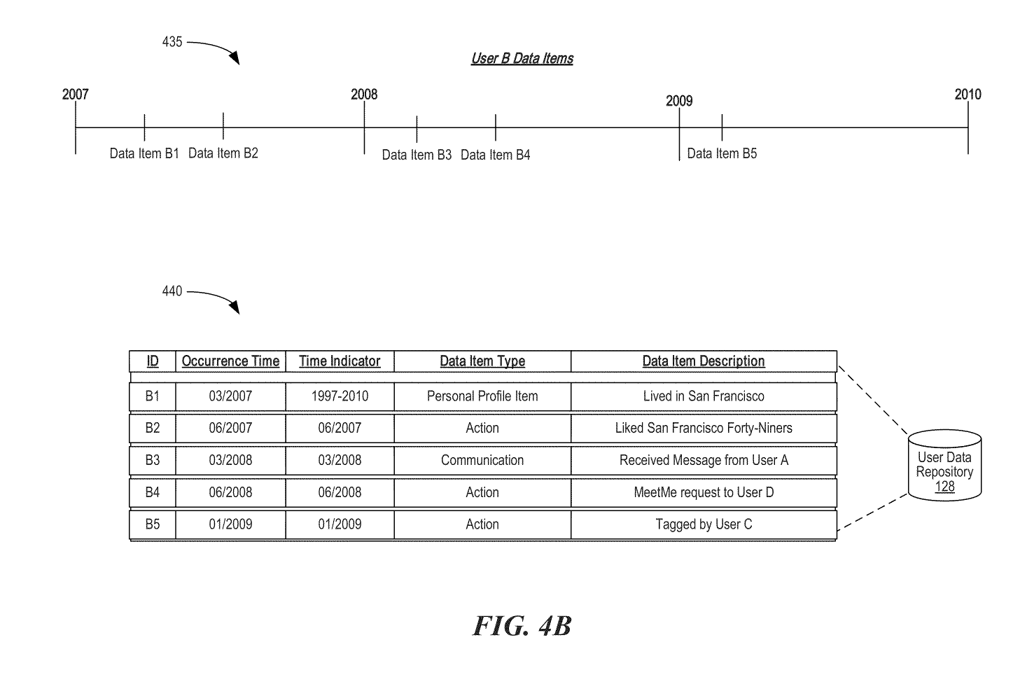

FIG. 4A and FIG. 4B depict diagrams illustrating examples of operation of a host server in processing incoming data items initiated by a first user A and a second user B, respectively. Referring first to FIG. 4A, which illustrates an example of incoming data items initiated by a first user A and storing the data items in a user data repository such as, for example, the user data repository 128 of FIG. 1.

The example illustrated in FIG. 4A includes a graphical representation of the occurrence times of various data items associated with a first user A that were received by a host server such as, for example, the host server 124 of FIG. 1. The example of FIG. 4A includes a time interval 425 and an example table 430 illustrating how the data items initiated by the first user A can be stored, according to one embodiment. The time interval 425 illustrates data items that are received during a time interval period starting in the year 2007 and ending in the year 2010. It is appreciated that the time interval period and the data items associated with the user A, as shown, are for illustrative purposes only.

The host server may receive any number of data items during any given time intervals. In the example of FIG. 4A, six data items A1-A6 associated with or initiated by the first user A are received by the host server at various times within the time interval 425. When a data item is received, the host server determines if a time indicator is included and, if not, the data item is associated with the occurrence time of the data item. Otherwise, if a time indicator is included, as is the case with data item A1 and data item A5, then the included time indicator is associated with the data item. The data item and the associated time indicator is subsequently stored in the user data repository 128, as shown in table 430.

Referring now to FIG. 4B, which illustrates an example of incoming data items initiated by a second user B and storing the data items in a user data repository such as, for example, the user data repository 128 of FIG. 1. The example illustrated in FIG. 4B includes a graphical representation of the occurrence times of various data items associated with a second user B that were received by a host server such as, for example, the host server 124 of FIG. 1. The example of FIG. 4B includes a time interval 435 and an example table 440 illustrating how the data items initiated by the second user B can be stored, according to one embodiment. The time interval 435 illustrates data items that are received during a time interval period starting in the year 2007 and ending in the year 2010. It is appreciated that the time interval period and the data items associated with the user B, as shown, are for illustrative purposes only.

The host server may receive any number of data items during any given time intervals. In the example of FIG. 4B, five data items B1-B5 associated with or initiated by the second user B are received by the host server at various times within the time interval 435. When a data item is received, the host server determines if a time indicator is included and, if not, the data item is associated with the occurrence time of the data item. Otherwise, if a time indicator is included, as is the case with data item B1, then the included time indicator is associated with the data item. The data item and the associated time indicator is subsequently stored in the user data repository 128, as shown in table 440.

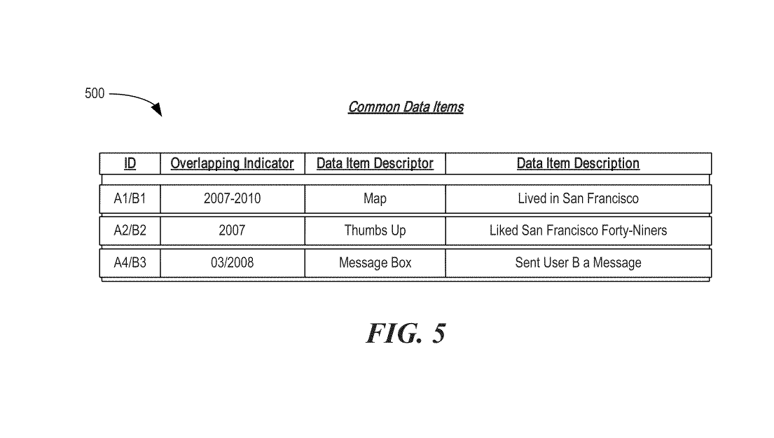

FIG. 5 depicts a table 500 illustrating an example of a first set of data items that are common to both a first user A and a second user B. A host server such as, for example, the host server 124 of FIG. 1 processes the data items associated with the first user A (i.e., the data items as received in FIG. 4A) and the data items associated with the second user B (i.e., the data items as received in FIG. 4B) to identify the first set of data items that are common to both the first user A and the second user B.

In one embodiment, the processing is initiated by the first user A sending a message for delivery to the host server indicating that he/she has an interest in exploring his/her commonalities with other users. In other embodiments, the processing may be initiated automatically by the host server in some instances or even by the second user B who may indicate that he/she has an interest in having this determination of commonalities computed and made available for display to other users of the web-based social network.

In one embodiment, the set of data items that are common to both the first user A and the second user B have overlapping time indicators. For instance, in the example of FIG. 5, the host server has identified three common data items between the first user A and the second user B. The first set of items may indicate the underlying data items associated with the first user A and the second user B that were compared to result in the common data items. In this case, the first common data item (i.e., “A1/B1”) is the result of comparing data item A1 of FIG. 4A and data item B1 of FIG. 4B. The host server determines the overlapping time indicator for the first common data item to be the time period from 2007 to 2010. Further, the host server also determines a data item descriptor for the first common data item. The data item descriptor is used to visually represent the common data item on the multi-user common social timeline. The data item descriptor can be any visually descriptive element such as, for example, a graphic or map.

As shown in the example of FIG. 5, the first common data item A1/B1 is a map representing the San Francisco and the surrounding area, the second common data item A2/B2 is a thumbs up, and the third common data item A4/B3 is a message (or communication) box. The host server uses the respective overlapping time indicators associated with the common set of data items and/or data item descriptors to place or otherwise indicate where and how a data item should be presented on the multi-user common social timeline. The data item descriptors are shown and discussed in greater detail with respect to FIG. 6 and FIG. 10.

When the overlapping indicator indicates a range of time, as is the case with the first common data item A1/B1, the host server can choose to illustrate the data item descriptor at the beginning of the overlapping time indictor period, at the end of the overlapping time indictor period, or anywhere in between on the multi-user common social timeline. In one embodiment, the host server may, by default, have one or more configuration settings providing that the data item descriptor be placed at the beginning of the overlapping time indictor period; however, the one or more configuration settings may be configurable by users and/or administrators.

The time indicators associated with a data item may include both fine and coarse identifiers. For example, a fine identifier may be a day or month and the coarse identifier may be the year. When determining the overlapping time periods it is possible that only the coarse identifiers of the compared data items overlap. Such is the case with respect to the second common data item A2/B2. In this case, both user A and user B indicated that they liked the San Francisco Forty-Niners; however, the data item associated with user A has a time indicator of “10/2007” and the data item associated with user B has a time indicator of “06/2007.” Thus, although the fine time identifiers do not overlap, the coarse identifiers do, and thus the host server determines the overlapping time indicator to be 2007. It is appreciated that even if the fine identifiers do overlap, that host server may still determine the time indicator based only on the coarse identifiers depending the configuration of the host server. That is, the overlapping time identifier determination by the host server can be configurable by the user and/or an administrator via one or more parameters.

FIG. 6 illustrates an example of a multi-user common social timeline 600 generated from the table illustrating the first set of data items that are common to both a first user A and a second user B of FIG. 5. The multi-user common social timeline 600 includes time scale identifiers 605A-B and data item descriptors 610A-C.

As discussed, a host server such as, for example, the host server 124 of FIG. 1, generates the multi-user common social timeline that illustrates a temporal relationship between each of the first set of data items that are common to both the first user A and the second user B. Within the multi-user common social timeline, the data items are represented by the data item descriptors 610A-C. That is, the data item descriptors are placed or displayed on the multi-user common social timeline 600 based on the determined overlapping time indicators.

The time scale identifiers 605A-B are time period identifiers selected by the host server based on the earliest and/or most recent determined overlapping time indicators that need to be displayed on the multi-user common social timeline 600. In the example of FIG. 6, a time scale identifier 605A is selected to be the year “2007” and the time scale identifier 605B is selected to be the year “2008.” The first two data item descriptors 610A and 610B are displayed on the multi-user common social timeline 600 between the time scale identifier 605A and 605B because these common data items have overlapping time indicators that fall within the 2007-2008 range. Similarly, the third data item descriptor is displayed on the multi-user common social timeline 600 after the time scale identifier 605B because the third common data item (i.e., “A4/B3”) occurred after 2008.

FIG. 7A and FIG. 7B illustrate example user interfaces showing a user-profile page (or pane) 700A for entering personal history and user-profile page (or pane) 700B for entering professional history, respectively. The user-profile pages 700A can be displayed to a user when, for example, the user selects a personal history tab 705 to modify his/her personal profile. Similarly, the user-profile page 700B can be displayed to a user when, for example, the user selects a professional history tab 706. In the example of FIG. 7A, a personal history page (or pane) is shown including a geography section 710 and an interests section 715. In the example of FIG. 7B, a professional history page (or pane) is shown including a work history section 720 and an education section 725. From these profile pages (or panes), a user can view, edit, select, and/or modify personal profile information.

FIG. 8 illustrates an example user interface showing a user-profile page 800, according to one embodiment. The user-profile page 800 can be displayed when a user logs on to the online social network and/or when a user selects a profile button such as, for example, profile button 802. The user-profile page also includes the user's status update field 804. The user's profile information can be shown and edited via various fields 806 and 808. In fields 806, the user's biographical information can be shown. In fields 808, the user's interest and hobbies can be shown. For example, the user can provide information relating to favorite music types and artists, favorite movies, favorite TV shows, favorite books, favorite sports, and other interests.

In the example shown, the user is able to access various features and services offered in the social network using the options provided in tab 802. In addition, the user may upload a photograph. For example, the options in tab 802 include selections allowing the user to access the home page, edit the profile, view friends, and/or review messages, etc.

When the user edits any of the various fields 806 and/or 808 and selects save, one or more new data items are sent to the host server for processing and saving as discussed herein.

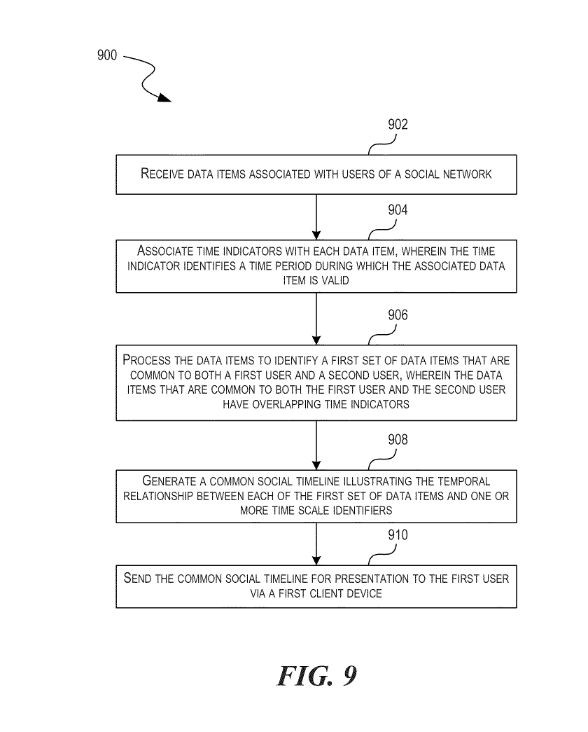

FIG. 9 depicts a flow diagram illustrating an example process 900 for generating a multi-user common social timeline for facilitating social discovery in a web-based social networking environment such as, for example web-based social networking environment 100 of FIG. 1, according to one embodiment.

The operations or steps illustrated with respect to FIG. 9 are discussed with respect to operation of a host server such as, for example, host server 124 of FIG. 1. However, the operations or steps may be performed in various embodiments by a mobile device, such as, for example, client device or user device 102 of FIG. 1, one or more processors, and/or other components, modules, engines, or tools discussed herein. Additional or fewer data flow operations are possible.

In process 902, the host server receives data items associated with users of a social network. For example, the host server may receive data items upon request from a user data repository such as, for example, the user data repository 124 of FIG. 1. Alternatively or additionally, the host server can receive the data items directly from an interaction/connection manager module such as, for example, the interaction/connection manager module 205 of FIG. 2. In one embodiment, the host server may monitor the received data items.

As previously discussed, one or more of the plurality of data items may comprise a social interaction between the users and/or a modification to profile information associated with one of the plurality of users of the web-based social network. Further, in some instances, the modification to the profile information indicates a geographical area including an associated time indicator.

In process 904, the host server associates time indicators with each data item. As discussed above, the time indicators identify time periods during which the associated data items are valid. As discussed above, any data item that does not include a corresponding time indicator (e.g., period during which the data item is valid), has a timing indicator selected by the host server and associated with the data item in the host server. Typically, the host server associated an occurrence time with the data item if the data item does not include a corresponding timing indicator. However, other determinations of timing indicators are also possible.

In process 906, the host server processes the plurality of data items to identify a first set of data items that are common to both a first user and a second user. The data items that are common to both the first user and the second user have overlapping time indicators. For example, a first data item associated with a first user may be compared to a second data item associated with a second user to determine whether the first data item and the second data item are the same or similar. For example, if the first user sends a message to the second user then the first data item associated with the first user corresponds to sending the message to the second user and the second data item associated with the second user corresponds to the second user receiving the message from the first user. In this case, the sent message and the received message occur at the same or similar time, and thus the first and second time periods overlap.

In another example, if the first user indicates via a personal profile that he/she has lived in San Francisco from 1997-Present and the second user indicates that he/she has lived in San Francisco from 2008-2010, then the host server can determine that the first user and the second user have lived in a common geographical area. Thus, the first data items (i.e., the first user living in San Francisco) and the second data item (i.e., the second user living in San Francisco) are the same or similar. However, in some embodiments, the host server must also ensure that the first data item and the second data item have overlapping time periods, as previously discussed with respect to FIG. 5.

In process 908, the host server generates the multi-user common social timeline that illustrates a temporal relationship between each of the first set of data items and one or more time scale identifiers. The common social timeline can be generated for illustration of the first set of data items in chronological or reverse chronological order of the overlapping time indicators. In one embodiment, the host server also generates a data item descriptor for each data item of the first set of data items, determines an overlapping time indicator for each data item of the first set of data items, and associates each data item descriptor with the corresponding overlapping time indicator, wherein each data item descriptor represents the data item on the common social timeline in a time slot determined based on the associated overlapping time indicator. Additionally, the host server selects one or more time scale identifiers based on the overlapping time indicators associated with the first set of data items. The time scale identifiers identify a time range of the common social timeline.

Lastly, in process 910, the host server sends the multi-user common social timeline to a client device for electronic presentation to the first user. In some embodiments, prior to sending the common social timeline to the client device, the host server receives an indication that the first user wants to explore common data items with the second user. In this case, the common social timeline is sent to the client device responsive to receiving the receiving the indication that the first user wants to explore common data items with the second user.

FIG. 10 illustrates an example user interface 1000 showing a multi-user common social timeline in a timeline pane 1004. The multi-user common social timeline illustrates a temporal relationship between two users of a web-based social network.

In the example of FIG. 10, the multi-user common social timeline is displayed to a first user “Billy Hong” and illustrates commonalities of data item with a second user “Emmanuelle Chriqui.” The multi-user common social timeline includes a plurality of time scale identifiers 1005 and data item descriptors 1010 and 1008. The user interface 1000 also includes a web-users pane where the first user can see data items indicating relevant actions that other users have recently taken with respect to the first user. In this example, the first user an expand button 1002 located next to the user that they want to explore commonalities with in order to display the multi-user common social timeline.

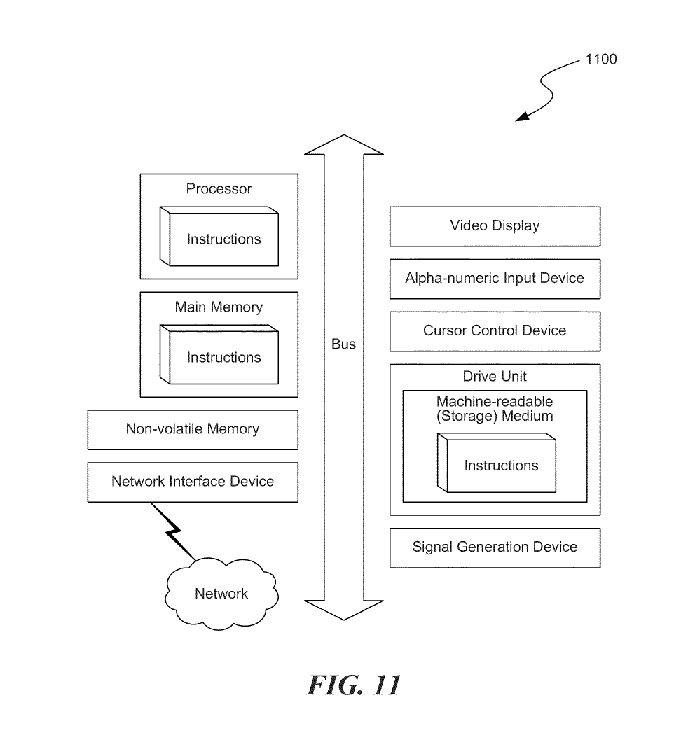

FIG. 11 shows a diagrammatic representation of a machine in the example form of a computer system 1100 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable medium is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method of facilitating social exploration in a social network, the method comprising:
receiving, at a computer system, a plurality of user data items associated with a plurality of users of the social network;
associating, at the computer system, a time indicator with each of the plurality of data items, wherein the time indicator identifies a time period during which the associated data item is valid;
processing, at the computer system, the plurality of data items to identify a first set of data items that are common to a first user and a second user of the plurality of users of the social network, wherein the data items that are common to the first user and the second user have overlapping time indicators; and
generating, at the computer system, a common social timeline that illustrates a temporal relationship between each of the first set of data items and one or more time scale identifiers.

2. The method of claim 1, further comprising:
generating, at the computer system, a data item descriptor for each data item of the first set of data items;
determining, at the computer system, an overlapping time indicator for each data item of the first set of data items; and
associating, at the computer system, each data item descriptor with the corresponding overlapping time indicator, wherein each data item descriptor represents the data item on the common social timeline in a time slot determined based on the associated overlapping time indicator.

3. The method of claim 2, wherein one or more of the plurality of data items comprises a modification to profile information associated with one of the plurality of users of the social network.

4. The method of claim 3, wherein the modification to the profile information indicates a geographical area including an associated time indicator.

5. The method of claim 4, wherein the data item descriptor comprises a map illustrating the geographical area which is common to both the first user and the second user during the overlapping time indicator.

6. The method of claim 2, wherein one or more of the plurality of data items comprises a social interaction between the first user and the second user.

7. The method of claim 6, wherein the data item descriptor comprises an indication of a type of the social interaction between the first user.

8. The method of claim 6, wherein the social interaction comprises one of an electronic text-based message, an indication that a user would like to meet another user, an indication that a user liked something, an indication that a virtual gift was sent or received, an indication that a wink was sent or received, or an indication that a user was tagged by another user or tagged another user.

9. The method of claim 1 wherein the common social timeline is generated for illustration of the first set of data items in chronological or reverse chronological order of the overlapping time indicators.

10. The method of claim 1 wherein processing the plurality of data items to identify the first set of data items that are common to both the first user and the second user comprises comparing one or more of the plurality of data items to each other to determine if the data items are related, wherein the related data items include those data items that are the same or similar.

11. The method of claim 1 wherein processing the plurality of data items further comprises:
identifying first data items and second data items from the plurality of data items, wherein the first data items are associated with the first user and the second data items are associated with the second user;
generating a first social timeline based on the first data items and a second social timeline based on the second data items; and
comparing the first social timeline and the second social timeline to identify the first set of data items that are common to both the first user and the second user.

12. The method of claim 1, further comprising:
prior to associating the plurality of time indicators with each of the plurality of data items, determining, at the computer system, if each data item of the plurality of data items includes a time indicator; and
determining the time indicator for each data item that does not already include one.

13. The method of claim 13, wherein the determined time indicator comprises an occurrence time of the data item.

14. The method of claim 1, further comprising:
sending, from the computer system, the common social timeline to a client device for electronic presentation to the first user.
prior to sending the common social timeline to the client device, receiving, at the computer system, an indication that the first user wants to explore common data items with the second user, wherein the common social timeline is sent to the client device responsive to receiving the receiving the indication that the first user wants to explore common data items with the second user.

15. The method of claim 1, further comprising:
selecting, at the computer system, the one or more time scale identifiers based on the overlapping time indicators associated with the first set of data items, wherein the time scale identifiers identify a time range of the common social timeline.

16. A machine-readable storage medium having stored thereon a set of instructions which when executed, causes a processor to perform a method of facilitating social exploration in a social network, the method comprising:
associating a plurality of time indicators with each of a plurality of data items associated with a plurality of users of the social network, wherein each time indicator identifies a time period during which the associated data item is valid;
processing the plurality of data items to identify a first set of data items that are common to a first user and a second user of the plurality of users of the social network, wherein the data items that are common to the first user and the second user have overlapping time indicators; and
generating a common social timeline that illustrates a temporal relationship between each of the first set of data items and one or more time scale identifiers.

17. The machine-readable storage medium of claim 16, the method further comprising:
generating a data item descriptor for each data item of the first set of data items;
determining an overlapping time indictor for each data item of the first set of data items; and
associating each data item descriptor with the corresponding overlapping time indicator, wherein each data item descriptor represents the data item on the common social timeline in a time slot determined based on the associated overlapping time indicator.

18. The machine-readable storage medium of claim 17, wherein one or more of the plurality of data items comprises a modification to personal profile information associated with one of the plurality of users of the social network, and wherein the modification to the profile information indicates a geographical area including an associated time indicator.

19. The machine-readable storage medium of claim 18, wherein the data item descriptor comprises a map illustrating the geographical area which is common to both the first user and the second user during the overlapping time indicator.

20. The machine-readable storage medium of claim 17, wherein one or more of the plurality of data items comprises a social interaction between the first user and the second user.

21. The machine-readable storage medium of claim 16 wherein the common social timeline is generated for illustration of the first set of data items in chronological order or reverse chronological order of the overlapping time indicators.

22. The machine-readable storage medium of claim 16, wherein processing the plurality of data items further comprises:
identifying first data items and second data items from the plurality of data items, wherein the first data items are associated with the first user and the second data items are associated with the second user;
generating a first social timeline based on the first data items and a second social timeline based on the second data items; and
comparing the first social timeline and the second social timeline to identify the first set of data items that are common to both the first user and the second user.

23. The machine-readable storage medium of claim 16, the method further comprising:
prior to associating the plurality of time indicators with each of the plurality of data items, determining, at the computer system, if each data item of the plurality of data items includes a time indicator; and
determining the time indicator for each data items that does not already include one.

24. The machine-readable storage medium of claim 23, wherein the determined time indicator comprises an occurrence time of the data item.

25. A system for facilitating social exploration in a social network, the system comprising:
a processing unit;
a memory unit having stored thereon instructions which when executed by the processing unit, cause the processing unit to:
receive a plurality of data items associated with a plurality of users of the social network;
associate a plurality of time indicators with each of the plurality of data items, wherein each time indicator identifies a time period during which the associated data item is valid;
process the plurality of data items to identify a first set of data items that are common to a first user and a second user of the plurality of users of the social network, wherein the data items that are common to the first user and the second user have overlapping time indicators; and
generate a common social timeline that illustrates a temporal relationship between each of the first set of data items and one or more time scale identifiers.

26. The system of claim 25, wherein the instructions, when executed by the processing unit, further cause the processing unit to:
generate a data item descriptor for each data item of the first set of data items;
determine an overlapping time indictor for each data item descriptor; and
associate each data item descriptor with the corresponding overlapping time indicator, wherein each data item descriptor represents the data item on the common social timeline in a time slot determined based on the associated overlapping time indicator.

27. The system of claim 26, wherein one or more of the plurality of data items comprises a modification to profile information associated with one of the plurality of users of the social network.

28. The system of claim 27, wherein the modification to the profile information indicates a geographical area including an associated time indicator, and wherein the data item descriptor comprises a map illustrating the geographical area which is common to both the first user and the second user during the overlapping time indicator.

29. The system of claim 26, wherein one or more of the plurality of data items comprises a social interaction between the first user and the second user.

30. The system of claim 29, wherein the data item descriptor comprises an indication of a type of the social interaction between the first user and the second user and the overlapping time indicator.

31. The system of claim 25, wherein the instructions, when executed by the processing unit, further cause the processing unit to:
identify first data items and second data items from the plurality of data items, wherein the first data items are associated with the first user and the second data items are associated with a second user;
generate a first social timeline based on the first data items and a second social timeline based on the second data items; and
compare the first social timeline and the second social timeline to identify the first set of data items that are common to both the first user and the second user.

32. The system of claim 25, wherein the instructions, when executed by the processing unit, further cause the processing unit to:
determine if each data item of the plurality of data items includes a time indicator prior to said associating the plurality of time indicators with each of the plurality of data items; and
determine the time indicator for each data item that does not already include an associated a time indicator.

33. A system for facilitating social exploration in a social network, the system comprising:
means for receiving a plurality of data items associated with a plurality of users of the social network;
means for associating a plurality of time indicators with each of the plurality of data items, wherein each time indicator identifies a time period during which the associated data item is valid;
means for processing the plurality of data items to identify a first set of data items that are common to a first user and a second user of the plurality of users of the social network, wherein the data items that are common to the first user and the second user have overlapping time indicators; and
means for generating a common social timeline that illustrates a temporal relationship between each of the first set of data items and one or more time scale identifiers.
